(19) United States
(12) Patent Application Publication
(10) Pub. No.: US 2026/0098186 A1
(43) Pub. Date: Apr. 9, 2026

(54) HOT-MELT ADHESIVE COMPOSITION, PRECOATED SURFACE MATERIAL FOR AUTOMOBILE INTERIOR, AUTOMOBILE INTERIOR MATERIAL, AND METHOD OF PRODUCING BONDED BODY

(71) Applicant: Sunstar Engineering Inc., Osaka (JP)

(72) Inventors: Hideyuki KOYANAGI, Osaka (JP); Yanmei ZHANG, Osaka (JP)

(73) Assignee: Sunstar Engineering Inc., Osaka (JP)

(21) Appl. No.: 19/039,604

(22) Filed: Jan. 28, 2025

(30) Foreign Application Priority Data
Oct. 3, 2024 (JP) 2024-174063

(51) Int. Cl. C09J 7/35; C09J 123/14; C09J 191/06

(52) U.S. Cl. CPC C09J 7/35; C09J 123/14; C09J 191/06; C09J 2203/354; C09J 2301/304; C09J 2301/408; C09J 2301/414; C09J 2301/50; C09J 2423/10; C09J 2491/00

(57) ABSTRACT

Provided is a hot-melt adhesive composition, comprising: an α-olefin (co)polymer (A) that is produced using a single-site catalyst and has a Shore A hardness of 80 or more; an α-olefin (co)polymer (B) that is produced using a single-site catalyst and has a Shore A hardness of less than 80; an ethylene-polar group-containing monomer copolymer (C); and a polypropylene-based wax (D), wherein the polypropylene-based wax (D) is comprised in an amount of 60 parts by mass to 300 parts by mass with respect to a total of 100 parts by mass of the α-olefin (co)polymer (A), the α-olefin (co)polymer (B), and the ethylene-polar group-containing monomer copolymer (C).

### CROSS REFERENCE TO RELATED APPLICATIONS

This application claims benefit of priority to Japanese Patent Application 2024-174063, filed Oct. 3, 2024, the entire content of which is incorporated herein by reference.

### TECHNICAL FIELD

The present disclosure relates to: a hot-melt adhesive composition; a precoated surface material for automobile interior using the same; and an automobile interior material.

### BACKGROUND ART

Hot-melt adhesives, which are solid at room temperature, are heat-melted, applied to substrates, and then solidified by cooling to bond the substrates together. Such hot-melt adhesives are solvent-free and thus advantageous over solvent-based adhesives in terms of productivity improvement and the like through omission of drying process and reduction in VOC (volatile organic compounds); therefore, the hot-melt adhesives are used in various applications, including the automobile production.

Automobile interior materials, such as door trims, instrument panels, headliners, rear trays, and pillars, are generally composed of a molded article and a surface material. As the molded article, a polyolefin molded article or an ABS molded article is mainly used. Meanwhile, as the surface material, for example, a polyolefin foam-lined soft polyvinyl chloride artificial leather, a polyolefin foam-lined olefin-based thermoplastic elastomer artificial leather, or a polyurethane foam-lined fabric is used. The molded article and the surface material are bonded via an adhesive by a vacuum molding method, a compression molding method, or the like.

Patent Document 1 discloses a precoated surface material for automobile interior that is characterized by being obtained by applying a hot-melt adhesive to the back surface of an automobile interior surface material in advance, which hot-melt adhesive comprises, as indispensable components: (A) an amorphous poly(α-olefin) having a melt viscosity in a range of 500 to 100,000 mPa·s/190° C.; (B) a tackifier resin having a softening point of 110° C. or higher as measured by a ring-and-ball method; and (C) a polypropylene-based wax having a melting point of 120° C. or higher, and has a weight ratio (A)/(C) of 100/50 to 100/100.

### Patent Document

Patent Document 1: JP 2004-284575A

### SUMMARY

In the case of using a hot-melt adhesive, a step of temporality storing a surface material coated with the hot-melt adhesive (precoated surface material) is required depending on the method (e.g., vacuum molding method). The precoated surface material is often handled in a sheet form and stored in a stacked state. When a precoated surface material is stored in a stacked state under a temperature and humidity environment of summertime, a conventional hot-melt adhesive may cause problems, such as blocking between the precoated surface materials and migration of some of the components of the hot-melt adhesive to the surface material side. Such blocking and component migration can be decreased by inserting a release paper or a release film between the precoated surface materials; however, this may be a problem from the standpoint of cost and workability. In addition, a conventional hot-melt adhesive may cause a problem of crack generation due to impact and vibration during transport.

Patent Document 1 mentions, for example, to provide: a precoated surface material for automobile interior materials, in which a non-blocking and non-sticky adhesive excellent in durability and adhesive properties is used; and a method of producing an automobile interior material, and to provide: a solvent-free precoated surface material for automobile interior materials, which exhibits good adhesion to olefin materials and excellent heat resistance; and a method of producing an automobile interior material (see, for example, [0013] to [0015] of Patent Document 1).

However, in Patent Document 1, the blocking resistance during storage of the precoated surface material in a stacked state is not actually examined and is thus unclear. In addition, the component migration resistance during storage of the precoated surface material in a stacked state and the crack resistance during transport are also unclear.

An object of the present disclosure is to provide a hot-melt adhesive that exhibits not only good adhesion to resin substrates, particularly polyolefin substrates such as polypropylene substrates, and good heat resistance, but also excellent blocking resistance and component migration resistance during storage of a precoated surface material in a stacked state, as well as excellent crack resistance during transport.

The present inventors intensively studied to discover that it is possible to obtain a hot-melt adhesive composition comprising a specific α-olefin (co)polymer (A), another specific α-olefin (co)polymer (B), an ethylene-polar group-containing monomer copolymer (C), and a polypropylene-based wax (D), in which (D) is comprised in a specific amount with respect to 100 parts by mass of (A) to (C). The present inventors also discovered that such a hot-melt adhesive composition exhibits not only good adhesion and heat resistance, but also excellent blocking resistance and component migration resistance even during storage of a precoated surface material in a stacked state, as well as excellent crack resistance during transport, and is preferable for precoated surface materials for automobile interior and automobile interior materials, thereby completing the present invention.

The present specification comprises the following embodiments.
<1> A hot-melt adhesive composition, comprising:
   an α-olefin (co)polymer (A) that is produced using a single-site catalyst and has a Shore A hardness of 80 or more;
   an α-olefin (co)polymer (B) that is produced using a single-site catalyst and has a Shore A hardness of less than 80;
   an ethylene-polar group-containing monomer copolymer (C); and
   a polypropylene-based wax (D),
   wherein the polypropylene-based wax (D) is comprised in an amount of 60 parts by mass to 300 parts by mass with respect to a total of 100 parts by mass of the α-olefin (co)polymer (A), the α-olefin (co)polymer (B), and the ethylene-polar group-containing monomer copolymer (C).
<2> The hot-melt adhesive composition according to <1>, wherein the α-olefin (co)polymer (A) comprises at least one selected from the group consisting of polypropylenes, ethylene-propylene copolymers, and propylene-butene copolymers.
<3> The hot-melt adhesive composition according to <1> or <2>, wherein the α-olefin (co)polymer (B) comprises a repeating unit derived from propylene as a part of a copolymerized component.
<4> The hot-melt adhesive composition according to any one of <1> to <3>, wherein the ethylene-polar group-containing monomer copolymer (C) comprises at least one selected from the group consisting of ethylene-vinyl acetate copolymers and ethylene-ethyl acrylate copolymers.
<5> The hot-melt adhesive composition according to any one of <1> to <4>, wherein the polypropylene-based wax (D) has a softening point of 90° C. or higher.
<6> The hot-melt adhesive composition according to any one of <1> to <5>, comprising a tackifier (E).
<7> The hot-melt adhesive composition according to <6>, wherein the tackifier (E) comprising at least one selected from the group consisting of hydrogenated petroleum resins, terpene resins, and hydrogenated terpene phenol resins.
<8> The hot-melt adhesive composition according to any one of <1> to <7>, comprising an antioxidant (F).
<9> The hot-melt adhesive composition according to any one of <1> to <8>, having a melt viscosity of 10,000 mPa·s to 50,000 mPa·s at 180° C.
<10> The hot-melt adhesive composition according to any one of <1> to <9>, which is for an automobile interior material.
<11> A precoated surface material for automobile interior, comprising:
   a surface material for automobile interior; and
   a hot-melt adhesive layer formed from the hot-melt adhesive composition according to any one of <1> to <10> on the back surface of the surface material for automobile interior.
<12> An automobile interior material, comprising:
   a molded article for automobile interior,
   the precoated surface material for automobile interior according to <11>, which is bonded to the molded article for automobile interior via the hot-melt adhesive layer.
<13> A method of producing a bonded body,
   wherein
   the bonded body comprises: a first substrate; and a second substrate bonded to the first substrate via a hot-melt adhesive layer formed from the hot-melt adhesive composition according to any one of <1> to <10>, and
   the method comprises a step of bringing a mold and the hot-melt adhesive composition into contact.
<14> A method of producing a hot-melt adhesive composition, the method comprising:
   preparing an α-olefin (co)polymer (A) that is produced using a single-site catalyst and has a Shore A hardness of 80 or more, an α-olefin (co)polymer (B) that is produced using a single-site catalyst and has a Shore A hardness of less than 80, an ethylene-polar group-containing monomer copolymer (C), and a polypropylene-based wax (D); and
   melt-mixing the polypropylene-based wax (D) in an amount of 60 parts by mass to 300 parts by mass with respect to a total of 100 parts by mass of the α-olefin (co)polymer (A), the α-olefin (co)polymer (B), and the ethylene-polar group-containing monomer copolymer (C).

### Effects of the Invention

The hot-melt adhesive composition of the present invention exhibits not only good adhesion and heat resistance, but also excellent blocking resistance and component migration resistance even during storage of a precoated surface material coated with the hot-melt adhesive composition in a stacked state, as well as excellent crack resistance during transport; therefore, the hot-melt adhesive composition of the present invention can be preferably used for the production of a precoated surface material for automobile interior, an automobile interior material, and the like.

### DETAILED DESCRIPTION

### <Hot-Melt Adhesive Composition>

The hot-melt adhesive composition of the present disclosure comprises: an α-olefin (co)polymer (A) that is produced using a single-site catalyst and has a Shore A hardness of 80 or more; an α-olefin (co)polymer (B) that is produced using a single-site catalyst and has a Shore A hardness of less than 80; an ethylene-polar group-containing monomer copolymer (C); and a polypropylene-based wax (D). In addition to these components (A) to (D), if necessary, the hot-melt adhesive composition of the present disclosure may further comprise one or more selected from the group consisting of a tackifier (E), an antioxidant (F), an inorganic filler (G), a plasticizer (H), other additives, and the like.

(A) α-Olefin (Co)Polymer that is Produced Using Single-Site Catalyst and has Shore A Hardness of 80 or More

The hot-melt adhesive composition of the present disclosure comprises an α-olefin (co)polymer (A) that is produced using a single-site catalyst and has a Shore A hardness of 80 or more (hereinafter, also referred to as “component (A)” or “α-olefin (co)polymer (A)”). The α-olefin (co)polymer (A) is a polyolefin that is produced using a single-site catalyst and may be crystalline. The α-olefin (co)polymer (A) is distinguished from other components described herein in terms of, for example, crystallinity, Shore A hardness, and/or molecular weight. Typically, the α-olefin (co)polymer (A)has a crystallinity of 20% or more. Typically, the α-olefin (co)polymer (A) has a Shore A hardness of 80 or more. Typically, the α-olefin (co)polymer (A) has a weight-average molecular weight of 40,000 or more.

The crystallinity of the α-olefin (co)polymer (A) may be 20% or more, 25% or more, 30% or more, or 35% or more. The crystallinity of the α-olefin (co)polymer (A) may be 100% or less, 98% or less, 95% or less, 90% or less, or 85% or less. The crystallinity is preferably equal to or more than the above-described lower limit value from the standpoint of allowing the effects of the present disclosure to be exerted more favorably. The crystallinity can be measured by, for example, differential scanning calorimetry. The term “crystalline” used herein may mean a property that a clear endothermic peak derived from a crystal portion is observed in differential scanning calorimetry, while the term “amorphous” used herein may mean a property that a clear endothermic peak derived from a crystal portion is not observed in differential scanning calorimetry.

The Shore A hardness of the α-olefin (co)polymer (A) may be 80 or more, 85 or more, 90 or more, or 95 or more, and it is preferably 80 or more. The Shore A hardness of the α-olefin (co)polymer (A) may be 100 or less, 99 or less, 98 or less, or 97 or less. The Shore A hardness may be used as an index of the cohesive strength of a resin, and can be an index of the adhesiveness at room temperature and in a hot state. The Shore A hardness of the α-olefin (co)polymer (A) is preferably in the above-described range from the standpoint of allowing the effects of the present disclosure to be exerted more favorably. The Shore A hardness of the α-olefin (co)polymer (A) can be measured in accordance with the method prescribed in JIS K6253-3:2012 (Rubber, vulcanized or thermoplastic-Determination of hardness).

The melting point of the α-olefin (co)polymer (A) may be 80° C. or higher, 90° C. or higher, 100° C. or higher, or 110° C. or higher, and it is preferably 80° C. or higher. The melting point of the α-olefin (co)polymer (A) may be 150° C. or lower, 140° C. or lower, 130° C. or lower, 120° C. or lower, 110° C. or lower, 100° C. or lower, or 90° C. or lower, and it is preferably 130° C. or lower. The melting point of the α-olefin (co)polymer (A) is preferably in the above-described range from the standpoint of allowing the effects of the present disclosure to be exerted more favorably. The melting point of the α-olefin (co)polymer (A) can be measured in accordance with the method prescribed in JIS K7121:2012 (Testing Methods for Transition Temperatures of Plastics).

The glass transition temperature of the α-olefin (co)polymer (A) may be −150° C. or higher, −125° C. or higher, −100° C. or higher, −75° C. or higher, −50° C. or higher, or −25° C. or higher. The glass transition temperature of the α-olefin (co)polymer (A) may be 20° C. or lower, 10° C. or lower, 0° C. or lower, −10° C. or lower, or −20° C. or lower, and it is preferably 0° C. or lower, more preferably −10° C. or lower. The glass transition temperature is preferably equal to or lower than the above-described upper limit also from the standpoint of low-temperature adhesion. The glass transition temperature of the α-olefin (co)polymer (A) can be measured in accordance with the method prescribed in JIS K7121:2012 (Testing Methods for Transition Temperatures of Plastics).

The α-olefin (co)polymer (A) is typically thermoplastic. The MFR of the α-olefin (co)polymer (A) may be 3 g/10 min or more, 5 g/10 min or more, 7 g/10 min or more, 10 g/10 min or more, 12 g/10 min or more, or 15 g/10 min or more, and it is preferably 5 g/10 min or more, more preferably 7 g/10 min or more. The MFR of the α-olefin (co)polymer (A) may be 40 g/10 min or less, 30 g/10 min or less, 20 g/10 min or less, 15 g/10 min or less, or 10 g/10 min or less. The MFR is preferably in a range of not less than the above-described lower limit also from the standpoint of reducing the melt viscosity and improving the coating stability. The MFR can be measured in accordance with JIS K7210.

The weight-average molecular weight of the α-olefin (co)polymer (A) may be 40,000 or more, 50,000 or more, 75,000 or more, 100,000 or more, 200,000 or more, 300,000 or more, or 500,000 or more, and it is preferably 100,000 or more. The weight-average molecular weight of the α-olefin (co)polymer (A) may be 5,000,000 or less, 2,000,000 or less, 1,500,000 or less, 1,200,000 or less, 1,000,000 or less, 800,000 or less, 600,000 or less, 400,000 or less, or 200,000 or less, and it is preferably 1,000,000 or less, for example, 600,000 or less. The weight-average molecular weight is preferably in the above-described range from the standpoint of allowing the effects of the present disclosure to be exerted more favorably. The weight-average molecular weight of the α-olefin (co)polymer (A) can be measured in accordance with the method prescribed in JIS K7252-1:2016 (Plastics—Determination of average molecular weight and molecular weight distribution of polymers using size-exclusion chromatography).

The α-olefin (co)polymer (A) is a polymer comprising a repeating unit derived from an olefin. The α-olefin (co)polymer (A) may be a homopolymer, a copolymer, or a mixture thereof. The copolymer may be in a form of any of a random copolymer, a block copolymer, a graft copolymer, and the like.

Examples of the repeating unit comprised in the α-olefin (co)polymer (A) comprise repeating units derived from ethylene, propylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and the like, and these repeating units may be comprised singly, or in combination of two or more thereof.

Among the above-described repeating units, the α-olefin (co)polymer (A) preferably comprises a repeating unit derived from propylene, and may comprise, for example, both of a repeating unit derived from propylene and a repeating unit derived from other α-olefin (e.g., ethylene). In the repeating units constituting (or forming) the α-olefin (co)polymer (A), the amount of the repeating unit derived from propylene may be 20% by mole or more, 30% by mole or more, 40% by mole or more, 50% by mole or more, 60% by mole or more, or 70% by mole or more, and it is preferably 30% by mole or more.

The α-olefin (co)polymer (A) is produced by polymerization of an α-olefin using a single-site catalyst. As compared to an α-olefin (co)polymer polymerized using a multi-site catalyst, an α-olefin (co)polymer polymerized using a single-site catalyst has more uniform molecular weight distribution and crystallinity distribution and comprises a smaller amount of low-molecular-weight component; therefore, an α-olefin (co)polymer polymerized using a single-site catalyst causes less tack and is more preferred from the standpoint of blocking resistance.

Specific examples of the α-olefin (co)polymer (A) comprise ethylene homopolymers, propylene homopolymers, 1-butene homopolymers, and copolymers of olefins, such as ethylene-propylene copolymers, propylene-1-butene copolymers, ethylene-1-butene copolymers, ethylene-1-octene copolymers, ethylene-1-hexene copolymers, and ethylene-propylene-1-butene copolymers, and preferred examples comprise propylene homopolymers, ethylene-propylene copolymers, and propylene-1-butene copolymers. These may be used singly, or in combination of two or more kinds thereof.

Examples of representative commercial products of the α-olefin (co)polymer (A) comprise: WINTEC Series manufactured by Japan Polypropylene Corporation, such as trade names “WINTEC WMX03”, “WINTEC WSX03”, and “WINTEC WSX03A”; L-MODU Series manufactured by Idemitsu Kosan Co., Ltd., such as trade names “L-MODU S901”, “L-MODU 5600”, and “L-MODU S400”; TAFMER Series manufactured by Mitsui Chemicals, Inc., such as trade names “TAFMER XM-7090”, “TAFMER XM-7080”, “TAFMER XM-7070”, “TAFMER XM-5090”, “TAFMER XM-5080”, “TAFMER XM-5070”, “TAFMER BL-2491M”, and “TAFMER DF110”; VERSIFY Series manufactured by Dow Chemical Company, such as trade names “VERSIFY 3000” and “VERSIFY 4200”; and VISTAMAXX Series manufactured by Exxon Mobil Corporation, such as trade names “VISTAMAXX 8880”, “VISTAMAXX 3588FL”, and “VISTAMAXX 3980FL”. The α-olefin (co)polymer (A) may be used singly, or in combination of two or more kinds thereof.

(B) α-Olefin (Co)Polymer that is Produced Using Single-Site Catalyst and has Shore A Hardness of Less than 80

The hot-melt adhesive composition of the present disclosure comprises an α-olefin (co)polymer (B) that is produced using a single-site catalyst and has a Shore A hardness of less than 80 (hereinafter, also referred to as “component (B)” or “α-olefin (co)polymer (B)”). The α-olefin (co)polymer (B) is a polyolefin that may have a melting point, and can provide flexibility. The α-olefin (co)polymer (B) is distinguished from other components described herein in terms of, for example, crystallinity and/or molecular weight. Typically, the α-olefin (co)polymer (B) is not amorphous. Typically, the α-olefin copolymer (B) has a Shore A hardness of less than 80. Typically, the α-olefin (co)polymer (B) has a weight-average molecular weight of 40,000 or more.

The Shore A hardness of the α-olefin (co)polymer (B) may be 20 or more, 30 or more, 40 or more, 50 or more, 60 or more, or 70 or more, and it is preferably 40 or more. The Shore A hardness of the α-olefin (co)polymer (B) may be less than 80, 75 or less, 70 or less, 65 or less, or 60 or less. The Shore A hardness of the α-olefin (co)polymer (B) is preferably in the above-described range from the standpoint of allowing the effects of the present disclosure to be exerted more favorably. The Shore A hardness of the α-olefin (co)polymer (B) can be measured in accordance with the method described above for the component (A).

The α-olefin (co)polymer (B) is typically thermoplastic. The MFR of the α-olefin (co)polymer (B) may be 3 g/10 min or more, 5 g/10 min or more, 7 g/10 min or more, 10 g/10 min or more, 12 g/10 min or more, or 15 g/10 min or more, and it is preferably 5 g/10 minor more, more preferably 7 g/10 minor more. The MFR of the α-olefin (co)polymer (B) may be 40 g/10 min or less, 30 g/10 min or less, 20 g/10 min or less, 15 g/10 min or less, or 10 g/10 min or less. The MFR is preferably in a range of not less than the above-described lower limit also from the standpoint of reducing the melt viscosity and improving the coating stability. The MFR can be measured in accordance with JIS K7210.

The weight-average molecular weight of the α-olefin (co)polymer (B) may be 40,000 or more, 50,000 or more, 75,000 or more, 100,000 or more, 200,000 or more, 300,000 or more, or 500,000 or more, and it is preferably 100,000 or more. The weight-average molecular weight of the α-olefin (co)polymer (B) may be 5,000,000 or less, 2,000,000 or less, 1,500,000 or less, 1,200,000 or less, 1,000,000 or less, 800,000 or less, 600,000 or less, 400,000 or less, or 200,000 or less, and it is preferably 1,000,000 or less, for example, 600,000 or less. The weight-average molecular weight is preferably in the above-described range from the standpoint of allowing the effects of the present disclosure to be exerted more favorably. The weight-average molecular weight of the α-olefin (co)polymer (B) can be measured in accordance with the method described above for the component (A).

The α-olefin (co)polymer (B) is a polymer comprising a repeating unit derived from an olefin. The α-olefin (co)polymer (B) may be a homopolymer, a copolymer, or a mixture thereof. The (co)polymer may be in a form of any of a random copolymer, a block copolymer, a graft copolymer, and the like.

Examples of the repeating unit comprised in the α-olefin (co)polymer (B) comprise repeating units derived from ethylene, propylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and the like, and these repeating units may be comprised singly, or in combination of two or more thereof.

Among the above-described repeating units, the α-olefin (co)polymer (B) preferably comprises a repeating unit derived from propylene, and may comprise, for example, both of a repeating unit derived from propylene and a repeating unit derived from other α-olefin (e.g., ethylene). In the repeating units constituting (or forming) the α-olefin (co)polymer (B), the amount of the repeating unit derived from propylene may be 20/a by mole or more, 30% by mole or more, 40% by mole or more, 50% by mole or more, 60% by mole or more, or 70% by mole or more, and it is preferably 30% by mole or more.

The α-olefin (co)polymer (B) is produced by polymerization of an α-olefin using a single-site catalyst. As compared to an α-olefin (co)polymer polymerized using a multi-site catalyst, an α-olefin (co)polymer polymerized using a single-site catalyst has more uniform molecular weight distribution and crystallinity distribution and comprises a smaller amount of low-molecular-weight component; therefore, an α-olefin (co)polymer polymerized using a single-site catalyst causes less tack and is more preferred from the standpoint of blocking resistance.

Specific examples of the α-olefin (co)polymer (B) comprise ethylene homopolymers, propylene homopolymers, 1-butene homopolymers, and copolymers of olefins, such as ethylene-propylene copolymers, propylene-1-butene copolymers, ethylene-1-butene copolymers, ethylene-1-octene copolymers, ethylene-1-hexene copolymers, and ethylene-propylene-1-butene copolymers, and preferred examples comprise ethylene-propylene copolymers, and propylene-1-butene copolymers. These may be used singly, or in combination of two or more kinds thereof.

Examples of representative commercial products of the α-olefin (co)polymer (B) comprise: TAFMER PN Series manufactured by Mitsui Chemicals, Inc., such as trade names “TAFMER PN-2070” and “TAFMER PN-3560”; INFUSE Series manufactured by Dow Chemical Company, such as trade names “INFUSE9807”, “INFUSE9817”, and “INFUSE9990”; and VISTAMAXX Series manufactured by Exxon Mobil Corporation, such as trade names “VISTAMAXX 6502” and “VISTAMAXX 6202”. The α-olefin (co)polymer (B) may be used singly, or in combination of two or more kinds thereof.

### (C) Ethylene-Polar Group-Containing Monomer Copolymer

The hot-melt adhesive composition of the present disclosure comprises an ethylene-polar group-containing monomer copolymer (C) (hereinafter, also referred to as “component (C)” or “copolymer (C)”). The ethylene-polar group-containing monomer copolymer (C) has repeating units derived from ethylene and a polar group-containing monomer. Specific examples of the polar group-containing monomer comprise: carboxylic acid vinyl esters, such as vinyl acetate; and (meth)acrylic acid alkyl esters, such as ethyl acrylate.

The copolymerization amount of the polar group-containing monomer may be 10% by mass or more, 20% by mass or more, and it is preferably 10% by mass or more. The copolymerization amount of the polar group-containing monomer may be 50% by mass or less, 40% by mass or less, 30% by mass or less, and it is preferably 30% by mass or less. The copolymerization amount of the polar group-containing monomer is preferably in the above-described range from the standpoint of allowing the effects of the present disclosure to be exerted more favorably.

The melting point of the ethylene-polar group-containing monomer copolymer (C) may be 50° C. or higher, 60° C. or higher, 70° C. or higher, 80° C. or higher, or 90° C. or higher, and it is preferably 50° C. or higher. The melting point of the ethylene-polar group-containing monomer copolymer (C) may be 150° C. or lower, 140° C. or lower, 130° C. or lower, 120° C. or lower, 110° C. or lower, or 100° C. or lower, and it is preferably 100° C. or lower. The melting point of the ethylene-polar group-containing monomer copolymer (C) is preferably in the above-described range from the standpoint of allowing the effects of the present disclosure to be exerted more favorably. The melting point of the ethylene-polar group-containing monomer copolymer (C) can be measured in accordance with the method prescribed in JIS K7121:2012 (Testing Methods for Transition Temperatures of Plastics).

Specific examples of the ethylene-polar group-containing monomer copolymer (C) comprise ethylene-vinyl acetate copolymers and ethylene-ethyl acrylate copolymers. These copolymers may be used singly, or in combination of two or more kinds thereof.

Examples of representative commercial products of the ethylene-polar group-containing monomer copolymer (C) comprise: ULTRATHENE Series manufactured by Tosoh Corporation, such as trade names “ULTRATHENE 680”, “UTTRATHENE 681”, “ULTRATHENE 684”, “ULTRATHENE 685”, “ULTRATHENE 710”, “ULTRATHENE 720”, “ULTRATHENE 722”, “ULTRATHENE 725”, and “ULTRATHENE 735”; EVAFLEX Series manufactured by Dow-Mitsui Polychemicals Co., Ltd., such as trade names “EVAFLEX EV210”, “EVAFLEX EV220”, “EVAFLEX EV310”, “EVAFLEX EV410”, “EVAFLEX EV420”, and “EVAFLEX EV450”; ethylene-vinyl acetate copolymers manufactured by ENEOS NUC Corporation, such as trade names “NUC-3830”, “NUC-3461”, and “NUC-3810”; REXPEARL Series manufactured by Japan Polyethylene Corporation, such as “REXPEARL A6200”; and ethylene-ethyl acrylate copolymers manufactured by ENEOS NUC Corporation, such as trade names “NUC-6570”, “NUC-6070”, and “NUC-6940”.

### (D) Polypropylene-Based Wax

The hot-melt adhesive composition of the present disclosure comprises a polypropylene-based wax (D) (hereinafter, also referred to as “component (D)”). The polypropylene-based wax (D) refers to a wax having a repeating unit derived from propylene. The polypropylene-based wax (D) generally has a low molecular weight (weight-average molecular weight of less than 40,000) and reduces the viscosity of a hot-melt adhesive, thereby providing coatability and wettability to an adherend. In addition, the polypropylene-based wax (D) increases the crystallinity of the α-olefin (co)polymers (A) and (B) and the softening point of the hot-melt adhesive, and can thereby improve the heat resistance.

The polypropylene-based wax (D) has a softening point of 90° C. or higher, 100° C. or higher, 110° C. or higher, 120° C. or higher, 130° C. or higher, 140° C. or higher, or 150° C. or higher, preferably 110° C. or higher, more preferably 120° C. or higher, still more preferably 130° C. or higher. The softening point of the polypropylene-based wax (D) may be 220° C. or lower, 210° C. or lower, 190° C. or lower, 180° C. or lower, 170° C. or lower, 160° C. or lower, or 150° C. or lower, and it is preferably 190° C. or lower, for example, 160° C. or lower. The softening point of the polypropylene-based wax (D) is preferably in the above-described range from the standpoint of allowing the effects of the present disclosure to be exerted more favorably. The softening point of the polypropylene-based wax (D) can be measured by a ring-and-ball method, specifically in accordance with JIS K6863:1994 (Testing methods for the softening point of hot-melt adhesives). The softening point of the polypropylene-based wax (D) is preferably equal to or lower than the above-described upper limit also from the standpoint of setting the melting temperature to be low and shortening the working time.

The weight-average molecular weight of the polypropylene-based wax (D) may be 3,000 or more, 5,000 or more, or 7,000 or more, and it is preferably 3,000 or more. The weight-average molecular weight of the polypropylene-based wax (D) may be less than 40,000, 35,000 or less, 30,000 or less, 20,000 or less, or 10,000 or less, and it is preferably 20,000 or less. The weight-average molecular weight is preferably in the above-described range from the standpoint of allowing the effects of the present disclosure to be exerted more favorably. The weight-average molecular weight of the polypropylene-based wax (D) can be measured in accordance with the method prescribed in JIS K7252-1:2016 (Plastics—Determination of average molecular weight and molecular weight distribution of polymers using size-exclusion chromatography).

The polypropylene-based wax (D) may comprise a repeating unit other than the repeating unit derived from propylene, for example, a repeating unit derived from an α-olefin. The polypropylene-based wax (D) may be a low-molecular-weight polyolefin, particularly a low-molecular-weight α-olefin-based polymer. The polypropylene-based wax (D) may be a homopolymer, a copolymer, a pyrolysis product of a homopolymer, a pyrolysis product of a copolymer, or a mixture thereof. The copolymer may be in a form of any of a random copolymer, a block copolymer, a graft copolymer, and the like.

Examples of the repeating unit that is comprised in the polypropylene-based wax (D) in addition to the repeating unit derived from propylene comprise repeating units derived from ethylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and the like, and these repeating units may be comprised singly, or in combination of two or more thereof.

In the repeating units constituting the polypropylene-based wax (D), the amount of the repeating unit derived from propylene may be 50% by mole or more, 60% by mole or more, 70% by mole or more, 80% by mole or more, or 90% by mole or more, and it is preferably 80% by mole or more.

Examples of representative commercial products of the polypropylene-based wax (D) comprise: VISCOL Series manufactured by Sanyo Chemical Industries, Ltd., such as trade names “VISCOL 660-P”, “VISCOL 550-P”, “VISCOL 440-P”, and “VISCOL 330-P”; Hi-WAX Series manufactured by Mitsui Chemicals, Inc., such as trade names “Hi-WAX 100P”, “Hi-WAX 200P”, “Hi-WAX 400P”, “Hi-WAX 800P”, “Hi-WAX 410P”, and “Hi-WAX 420P”; LICOCENE Series manufactured by Clariant Chemicals Ltd., such as trade names “LICOCENE PP6102”, “LICOCENE PP6502”, and “LICOCENE PP7502”; and L-C Series manufactured by Chusei Oil Co., Ltd., such as trade names “L-C503NC”, “L-C502NC”, “L-C501NC”, “L-C503N”, “L-C502N”, and “L-C525N”. The polypropylene-based wax (D) may be used singly, or in combination of two or more kinds thereof. Further, a wax other than the polypropylene-based wax may be blended within a range that does not deteriorate the desired physical properties.

### (E) Tackifier

The hot-melt adhesive composition of the present disclosure may also comprise a tackifier (E)(hereinafter, also referred to as “component (E)”). The tackifier (E) can improve the tackiness when melted.

The tackifier (E) has a softening point of 90° C. or higher, 100° C. or higher, 110° C. or higher, 120° C. or higher, 130° C. or higher, 140° C. or higher, or 150° C. or higher, preferably 110° C. or higher, more preferably 120° C. or higher, still more preferably 130° C. or higher. The softening point of the tackifier (E) may be 220° C. or lower, 210° C. or lower, 190° C. or lower, 180° C. or lower, 170° C. or lower, 160° C. or lower, or 150° C. or lower, and it is preferably 190° C. or lower, for example, 160° C. or lower. The softening point of the tackifier (E) is preferably in the above-described range from the standpoint of allowing the effects of the present disclosure to be exerted more favorably. The softening point of the tackifier (E) can be measured by a ring-and-ball method, specifically the method prescribed in JIS K6863:1994 (Testing methods for the softening point of hot-melt adhesives). The softening point of the tackifier (E) is preferably equal to or lower than the above-described upper limit also from the standpoint of setting the melting temperature to be low and shortening the working time.

Examples of the tackifier (E) comprise rosin resins, rosin esters, disproportionated rosin esters, hydrogenated rosin esters, polymerized rosins, aliphatic hydrocarbon resins, aliphatic aromatic copolymer resins, aromatic petroleum resins, hydrogenated petroleum resins, terpene resins, hydrogenated terpene resins, aromatic modified terpene resins, hydrogenated products of aromatic modified terpene resins, terpene phenol resins, hydrogenated terpene phenol resins, styrene resins, coumarone resins, and indene resins. Thereamong, from the standpoint of the compatibility with a polyolefin, preferred examples comprise hydrogenated petroleum resins, terpene resins, and terpene phenol resins. The tackifier (E) is distinguished from other components such as a polyolefin in terms of the presence or absence of an intramolecular double bond, an intramolecular polar group, an intramolecular hydrocarbon group, and the like.

Examples of representative commercial products of the tackifier (E) comprise: ARKON Series manufactured by Arakawa Chemical Industries, Ltd., such as trade names “ARKON P-90”, “ARKON P-100”, “ARKON P-115”, “ARKON P-140”, “ARKON M-90”, “ARKON M-100”, “ARKON M-115”, and “ARKON M-135”; “I-MARV” Series manufactured by Idemitsu Kosan Co., Ltd., such as trade names “I-MARV S-100”, “I-MARV S-110”, “I-MARV P-100”, “I-MARV P-125”, and “I-MARV P-140”; T-REZ Series manufactured by ENEOS Corporation, such as trade names “T-REZ HA103”, “T-REZ HA105”, “T-REZ HA125”, “T-RFZ HB125”, and “T-REZ OP501”; YS RESIN Series and YS POLYSTER Series manufactured by Yasuhara Chemical Co., Ltd., such as trade names “YS RESIN PX1250”, “YS RESIN PX1150”, “YS RESIN PX1000”, “YS RESIN PX1150N”, “YS RESIN T0125”, “YS RESIN TO115”, “YS RESIN TO105”, “YS POLYSTER T160”, “YS POLYSTER T145”, “YS POLYSTER T130”, “YS POLYSTER T115”, “YS POLYSTER T100”, and “YS POLYSTER UH115”; and FTR Series manufactured by Mitsui Chemicals, Inc., such as trade names “FTR6100”, “FTR6110”, and “FTR6125”. The tackifier (E) may be used singly, or in combination of two or more kinds thereof. Further, a tackifier having a softening point of lower than 90° C. may be blended within a range that does not deteriorate the desired physical properties.

### (F) Antioxidant

The hot-melt adhesive composition of the present disclosure may also comprise an antioxidant (F) (hereinafter, also referred to as “component (F)”). By incorporating the antioxidant (F), the thermal stability is improved, which may be preferred from the standpoint of allowing the effects of the present disclosure to be exerted favorably.

Examples of the antioxidant (F) comprise hindered phenols, polyphenols, bisphenols, phosphates, thioethers, hydrotalcites, benzimidazoles, and aromatic secondary amines.

Examples of representative commercial products of the antioxidant (F) comprise: IRGANOX Series manufactured by BASF, Ltd., such as trade names “IRGANOX 1010”, “IRGANOX 1035”, “IRGANOX 1076”, “IRGANOX 1098”, “IRGANOX 1330”, “IRGANOX 245”, “IRGANOX 259”, “IRGANOX 3114”, “IRGANOX 565”, and “IRGAFOS 168”; and ADK STAB Series manufactured by ADEKA Corporation, such as trade names “ADK STAB AO-20”, “ADK STAB AO-30”, “ADK STAB AO-40”, “ADK STAB AO-50”, “ADK STAB AO-60”, “ADK STAB AO-80”, “ADK STAB AO-330”, “ADK STAB PEP-8”, “ADK STAB PEP-36”, “ADK STAB HP-10”, “ADK STAB 2112”, and “ADK STAB AO-412S”. The antioxidant (F) may be used singly, or in combination of two or more kinds thereof.

### (G) Inorganic Filler

The hot-melt adhesive composition of the present disclosure may also comprise an inorganic filler (G) (hereinafter, also referred to as “component (G)”). By adding the inorganic filler (G), the adhesion, the dripping properties, the specific gravity, and the like can be adjusted.

Examples of the inorganic filler (G) comprise calcium carbonates (heavy calcium carbonate, surface-untreated calcium carbonate, surface-treated calcium carbonate (e.g., aliphatic acid-treated calcium carbonate), and needle-like crystalline calcium), silica (e.g., fumed silica, hydrophobic silica, and precipitating), talc, mica (isinglass), clay, chrysotile, wollastonite, carbon black, graphite, balloons (e.g., shirasu balloon, glass balloon, and silica balloon), inorganic fibers (e.g., glass fibers and metal fibers), titanium oxide, aluminum oxide, aluminum borate, silicon carbide, silicon nitride, potassium titanate, magnesium borate, titanium diboride, aluminum flakes, aluminum powder, and iron powder. The inorganic filler (G) may be used singly, or in combination of two or more kinds thereof.

### (H) Plasticizer

The hot-melt adhesive composition of the present disclosure may also comprise a plasticizer (H) (hereinafter, also referred to as “component (H)”). The plasticizer (H) is an oily substance, such as a chain alkyl group-containing low-molecular-weight compound or an olefin oligomer. The plasticizer (H) reduces the viscosity of a hot-melt adhesive and can thereby improve the coatability and the wettability to an adherend.

The weight-average molecular weight of the plasticizer (H) may be 100 or more, 300 or more, 500 or more, or 1,000 or more. The weight-average molecular weight of the plasticizer (H) may be less than 20,000, 16,000 or less, 12,000 or less, 5,000 or less, or 3,000 or less, and it is preferably 12,000 or less. The weight-average molecular weight is preferably in the above-described range from the standpoint of allowing the effects of the present disclosure to be exerted more favorably. The weight-average molecular weight of the plasticizer (H) can be measured in accordance with the method prescribed in JIS K7252-1:2016 (Plastics—Determination of average molecular weight and molecular weight distribution of polymers using size-exclusion chromatography).

Examples of the plasticizer (H) comprise liquid paraffin, process oils, phthalic acid-based plasticizers, butene oligomers, butadiene oligomers, liquid-like ethylene-propylene oligomers, and liquid-like rubbers; however, from the standpoint of compatibility, the plasticizer (H) is preferably a butene oligomer or a liquid-like ethylene-propylene oligomer.

Examples of representative commercial products of the plasticizer (H) comprise: POLYBUTENE Series manufactured by NOF Corporation, such as trade names “NOF POLYBUTENE ON”, “NOF POLYBUTENE 015N”, “NOF POLYBUTENE 3N”, “NOF POLYBUTENE ION”, “NOF POL YBUTENE 30N”, and “NOF POLYBUTENE 200N”; and LUCANT Series manufactured by Mitsui Chemicals, Inc., such as trade names “LUCANT LX004”, “LUCANT LX010”, “LUCANT LX020”, “LUCANT LX100”, “LUCANT LX200”, “LUCANT LX400”, “LUCANT LX900Z”, “LUCANT A-5515”, and “LUCANT A-5260”. The plasticizer (H) may be used singly, or in combination of two or more kinds thereof.

### (I) Other Components

In addition to the above-described components, if necessary, the hot-melt adhesive composition of the present disclosure may further comprise other components (I) (hereinafter, also referred to as “components (I)”). Examples of the other components (I) comprise: colorants (e.g., red iron oxide, titanium oxide, other coloring pigments, and dyes); organic solvents (e.g., methanol, ethanol, isopropyl alcohol, butanol, acetone, methyl ethyl ketone, ligroin, ethyl acetate, tetrahydrofuran, n-hexane, heptane, and isoparaffin-based high-boiling-point solvents); adhesion improver (adhesion reinforcement agent or primer) (e.g., silane coupling agents, such as vinyltrimethoxysilane, vinyltriethoxysilane, aminosilane, mercaptosilane, and epoxysilane; and epoxy compounds, such as glycidyl ether having a polyoxyalkylene skeleton); vulcanization accelerators (e.g., guanidines, aldehyde-amines, aldehyde-ammonias, thiazoles, sulfenamides, thioureas, thiurams, dithiocarbamates, and xanthates); vulcanization aids (e.g., long-chain fatty acids having 12 or more carbon atoms, such as stearic acid, oleic acid, and palmitic acid; and metal oxides, such as zinc oxide, magnesium oxide, and lead oxide); age inhibitors (e.g., hindered phenols, mercaptans, sulfides, dithiocarboxylates, thioureas, thiophosphates, and thioaldehydes); UV absorbers/light stabilizers (e.g., benzotriazoles and hindered amines); thixotropic agents (e.g., colloidal silica, organic bentonite, fatty acid amides, and hydrogenated castor oil); and resin/polymer components other than the above-described ones (e.g., thermosetting resins and thermoplastic resins). These components may be used singly, or in combination of two or more kinds thereof.

The hot-melt adhesive composition of the present disclosure may be of a solvent-free type, and does not have to comprise a solvent.

The hot-melt adhesive composition of the present disclosure may be of a non-reactive type, and does not have to comprise a reactive additive.

### Composition

The amount of the component (A) may be 2.5% by mass or more, 5% by mass or more, 7.5% by mass or more, 10% by mass or more, 12.5% by mass or more, or 15% by mass or more, with respect to 100% by mass of the hot-melt adhesive composition, and it is preferably 5% by mass or more.

The amount of the component (A) may be 30% by mass or less, 25% by mass or less, 20% by mass or less, 15% by mass or less, 10% by mass or less, or 7.5% by mass or less, with respect to 100% by mass of the hot-melt adhesive composition, and it is preferably 10% by mass or less.

The amount of the component (B) may be 2.5% by mass or more, 5% by mass or more, 7.5% by mass or more, 10% by mass or more, 12.5% by mass or more, or 15% by mass or more, 17.5% by mass or more, 20% by mass or more, 22.5% by mass or more, or 25% by mass or more, with respect to 100% by mass of the hot-melt adhesive composition, and it is preferably 15% by mass or more, more preferably 20% by mass or more.

The amount of the component (B) may be 40% by mass or less, 35% by mass or less, 30% by mass or less, 25% by mass or less, 20% by mass or less, or 15% by mass or less, with respect to 100% by mass of the hot-melt adhesive composition, and it is preferably 30% by mass or less.

The amount of the component (C) may be 2.5% by mass or more, 5% by mass or more, 7.5% by mass or more, 10% by mass or more, 12.5% by mass or more, or 15% by mass or more, with respect to 100% by mass of the hot-melt adhesive composition, and it is preferably 5% by mass or more, more preferably 7.5% by mass or more.

The amount of the component (C) may be 25% by mass or less, 20% by mass or less, 15% by mass or less, 12.5% by mass or less, 10% by mass or less, or 7.5% by mass or less, with respect to 100% by mass of the hot-melt adhesive composition, and it is preferably 15% by mass or less, more preferably 12.5% by mass or less.

The amount of the component (D) may be 10% by mass or more, 15% by mass or more, 20% by mass or more, 25% by mass or more, 30% by mass or more, 35% by mass or more, 40% by mass or more, 45% by mass or more, or 50% by mass or more, with respect to 100% by mass of the hot-melt adhesive composition, and it is preferably 30% by mass or more.

The amount of the component (D) may be 75% by mass or less, 70% by mass or less, 65% by mass or less, 60% by mass or less, 55% by mass or less, 50% by mass or less, or 45% by mass or less, with respect to 100% by mass of the hot-melt adhesive composition, and it is preferably 65% by mass or less, more preferably 50% by mass or less.

The amount of the component (E) may be 2.5% by mass or more, 5% by mass or more, 7.5% by mass or more, 10% by mass or more, 12.5% by mass or more, 15% by mass or more, 17.5% by mass or more, 20% by mass or more, 22.5% by mass or more, or 25% by mass or more, with respect to 100% by mass of the hot-melt adhesive composition, and it is preferably 10% by mass or more, more preferably 15% by mass or more.

The amount of the component (E) may be 40% by mass or less, 35% by mass or less, 30% by mass or less, 25% by mass or less, 20% by mass or less, or 15% by mass or less, with respect to 100% by mass of the hot-melt adhesive composition, and it is preferably 30% by mass or less.

The amount of the component (F) may be 0.01% by mass or more, 0.05% by mass or more, 0.1% by mass or more, 0.3% by mass or more, 0.5% by mass or more, 0.75% by mass or more, or 1% by mass or more, with respect to 100% by mass of the hot-melt adhesive composition, and it is preferably 0.1% by mass or more.

The amount of the component (F) may be 5% by mass or less, 4% by mass or less, 3% by mass or less, 2% by mass or less, or 1% by mass or less, with respect to 100% by mass of the hot-melt adhesive composition, and it is preferably 3% by mass or less.

The amount of the component (G) may be 1% by mass or more, 2.5% by mass or more, 5% by mass or more, 7.5% by mass or more, 10/a by mass or more, 12.5% by mass or more, or 15% by mass or more, with respect to 100% by mass of the hot-melt adhesive composition, and it is preferably 2.5% by mass or more, more preferably 5% by mass or more.

The amount of the component (G) may be 30% by mass or less, 25% by mass or less, 20% by mass or less, 15% by mass or less, 10% by mass or less, or 5% by mass or less, with respect to 100% by mass of the hot-melt adhesive composition.

The amount of the other components (1) in the hot-melt adhesive composition of the present disclosure may be adjusted as appropriate in accordance with the respective components thereof.

A total amount of the other components (I) may be 0.1% by mass or more, 0.2% by mass or more, 0.5% by mass or more, 1% by mass or more, 2.5% by mass or more, or 5% by mass or more, with respect to 100% by mass of the hot-melt adhesive composition.

A total amount of the other components (I) may be 30% by mass or less, 25% by mass or less, 20% by mass or less, 15% by mass or less, 10% by mass or less, 7.5% by mass or less, or 5% by mass or less, 2.5% by mass or less, or 1% by mass or less, with respect to 100% by mass of the hot-melt adhesive composition, and it is preferably 20% by mass or less, more preferably 10% by mass or less.

The amount of each component of the other components (1) may be 0.01% by mass or more, 0.05% by mass or more, 0.1% by mass or more, 0.3% by mass or more, 0.5% by mass or more, 0.75% by mass or more, 1% by mass or more, or 2.5% by mass or more, with respect to 100% by mass of the hot-melt adhesive composition. Further, the amount of each component of the other components (I) may be 10% by mass or less, 7.5% by mass or less, 5% by mass or less, 2.5% by mass or less, or 1% by mass or less, with respect to 100% by mass of the hot-melt adhesive composition.

A total amount of the components (A) and (B) may be 5% by mass or more, 10% by mass or more, 15% by mass or more, 20% by mass or more, 25% by mass or more, 30% by mass or more, 35% by mass or more, 40% by mass or more, 45% by mass or more, or 50% by mass or more, with respect to 100% by mass of the hot-melt adhesive composition, and it is preferably 20% by mass or more, more preferably 30% by mass or more.

A total amount of the components (A) and (B) may be 80% by mass or less, 70% by mass or less, 60% by mass or less, 50% by mass or less, 40% by mass or less, or 30% by mass or less, with respect to 100% by mass of the hot-melt adhesive composition, and it is preferably 60% by mass or less. A total amount of the components (A) and (B) is preferably in the above-described range from the standpoint of allowing the effects of the present disclosure to be exerted favorably.

The amount of the component (A) may be 15 parts by mass or more, 20 parts by mass or more, 25 parts by mass or more, more than 50 parts by mass, 75 parts by mass or more, or 100 parts by mass or more, with respect to 100 parts by mass of the component (B), and it is preferably 15 parts by mass or more, more preferably 20 parts by mass or more, still more preferably 25 parts by mass or more.

The amount of the component (A) may be 500 parts by mass or less, 450 parts by mass or less, 400 parts by mass or less, 350 parts by mass or less, 300 parts by mass or less, 200 parts by mass or less, 150 parts by mass or less, 100 parts by mass or less, 75 parts by mass or less, or 50 parts by mass or less, with respect to 100 parts by mass of the component (B), and it is preferably 100 parts by mass or less, more preferably 75 parts by mass or less, still more preferably 50 parts by mass or less. The amount of the component (A) is preferably in the above-described range from the standpoint of allowing the effects of the present disclosure to be exerted favorably.

The amount of the component (D) may be more than 60 parts by mass, 65 parts by mass or more, 70 parts by mass or more, 80 parts by mass or more, 90 parts by mass or more, 100 parts by mass or more, 110 parts by mass or more, or 120 parts by mass or more, with respect to a total of 100 parts by mass of the components (A), (B), and (C), and it is preferably 60 parts by mass or more, more preferably 80 parts by mass or more, still more preferably 90 parts by mass or more.

The amount of the component (D) may be 300 parts by mass or less, 250 parts by mass or less, 200 parts by mass or less, 180 parts by mass or less, 150 parts by mass or less, or 120 parts by mass or less, with respect to a total of 100 parts by mass of the components (A), (B), and (C), and it is preferably 300 parts by mass or less, more preferably 250 parts by mass or less, still more preferably 180 parts by mass or less. The amount of the component (D) is preferably in the above-described range from the standpoint of allowing the effects of the present disclosure to be exerted favorably. When the amount of the component (D) is equal to or more than the above-described lower limit, the crystallinity of the α-olefin copolymers (A) and (B) can be improved, and the softening point of a hot-melt adhesive can be increased, and the heat resistance can be improved. When the amount of the component (D) is equal to or less than the above-described upper limit, the crack resistance can be improved.

The amount of the component (E) may be 10 parts by mass or more, 20 parts by mass or more, 30 parts by mass or more, 40 parts by mass or more, 50 parts by mass or more, or 60 parts by mass or more, with respect to a total of 100 parts by mass of the components (A), (B), and (C), and it is preferably 20 parts by mass or more, more preferably 40 parts by mass or more.

The amount of the component (E) may be 150 parts by mass or less, 125 parts by mass or less, 100 parts by mass or less, 75 parts by mass or less, 50 parts by mass or less, or 30 parts by mass or less, with respect to a total of 100 parts by mass of the components (A), (B), and (C), and it is preferably 100 parts by mass or less, more preferably 75 parts by mass or less. The amount of the component (E) is preferably in the above-described range from the standpoint of allowing the effects of the present disclosure to be exerted favorably.

The amount of the component (G) may be 5 parts by mass or more, 10 parts by mass or more, 15 parts by mass or more, 20 parts by mass or more, 25 parts by mass or more, or 30 parts by mass or more, with respect to a total of 100 parts by mass of the components (A), (B), and (C), and it is preferably 10 parts by mass or more, more preferably 20 parts by mass or more.

The amount of the component (G) may be 75 parts by mass or less, 60 parts by mass or less, 50 parts by mass or less, 40 parts by mass or less, 30 parts by mass or less, or 20 parts by mass or less, with respect to a total of 100 parts by mass of the components (A), (B), and (C), and it is preferably 60 parts by mass or less, more preferably 40 parts by mass or less. The amount of the component (G) is preferably in the above-described range from the standpoint of allowing the effects of the present disclosure to be exerted favorably.

### Physical Property

The hot-melt adhesive composition of the present disclosure may have a melt viscosity at 180° C., which is a common coating temperature of a hot-melt adhesive, of 5,000 mPa·s or more, 7,000 mPa·s or more, 10,000 mPa·s or more, 12,000 mPa·s or more, 15,000 mPa·s or more, 20,000 mPa·s or more, or 25,000 mPa·s or more, and the melt viscosity at 180° C. is preferably 7,000 mPa s or more, more preferably 10,000 mPa or more.

The hot-melt adhesive composition of the present disclosure may have a melt viscosity at 180° C., which is a common coating temperature of a hot-melt adhesive, of 200,000 mPa·s or less, 150,000 mPa·s or less, 100,000 mPa·s or less, 50,000 mPa·s or less, 30,000 mPa s or less, or 20,000 mPa·s or less, and the melt viscosity at 180° C. is preferably 100,000 mPa·s or less, more preferably 50,000 mPa·s or less.

The melt viscosity is preferably in the above-described range since this makes dripping and coating unevenness less likely to occur at the time of applying the hot-melt adhesive composition to an adherend. The melt viscosity is a value measured using a parallel plate-type rheometer (MCR102e, manufactured by Anton Paar GmbH) at a temperature of 180° C., a shear rate of 4.3 sec⁻¹, and a clearance of 0.5 mm.

### <Method of Producing Hot-Melt Adhesive Composition>

The hot-melt adhesive composition of the present disclosure can be produced by mixing the components (A) to (D) with heating as appropriate. The hot-melt adhesive composition of the present disclosure can be produced by, for example, adding the components (A) to (D) to a heat-mixing stirrer along with, if necessary, the components (E) and (F) and/or other components at once or sequentially, and mixing these components with heating as appropriate.

The method of producing a hot-melt adhesive according to the present disclosure comprise:
preparing an α-olefin (co)polymer (A) that is produced using a single-site catalyst and has a Shore A hardness of 80 or more, an α-olefin (co)polymer (B) that is produced using a single-site catalyst and has a Shore A hardness of less than 80, an ethylene-polar group-containing monomer copolymer (C), and a polypropylene-based wax (D); and
melt-mixing the polypropylene-based wax (D) in an amount of 60 parts by mass to 300 parts by mass with respect to a total of 100 parts by mass of the α-olefin (co)polymer (A), the α-olefin (co)polymer (B), and the ethylene-polar group-containing monomer copolymer (C).

### <Bonded Body and Production Method Thereof>

A bonded body of the present disclosure comprises: a first substrate; and a second substrate bonded to the first substrate via a hot-melt adhesive layer formed from the hot-melt adhesive composition.

A method of producing the bonded body of the present disclosure comprises: a step of applying the hot-melt adhesive composition of the present disclosure to one surface of a first substrate to form a hot-melt adhesive layer (coating step); and a step of bonding the first substrate with a second substrate via the hot-melt adhesive layer (bonding Step).

The method of producing the bonded body of the present disclosure may further comprise a step of crystallizing the hot-melt adhesive layer (curing step).

### Substrate

Substrates used as the first and the second substrates are not particularly limited, and examples thereof comprise substrates made of, for example: woody materials; plastic materials, such as polyolefins, polyvinyl chlorides, polyurethanes, polyesters, and epoxy resins; foams of the above-exemplified plastic materials; rubber materials, such as natural rubber and synthetic rubber; metal materials, such as aluminum, iron, and stainless steel; and inorganic materials, such as ceramics. The shape of each substrate is also not particularly limited, and each substrate may have the shape of a sheet, a foil, a plate, a molded body, or the like. The substrates may each consist of one kind of material, or may be composed of two or more kinds of materials. The material of the surface of the substrate on which the adhesive layer is formed is preferably a non-metal material, more preferably any of the above-described resins, still more preferably a polyolefin, particularly a polypropylene.

### Coating Step

In the coating step, as a method of applying the hot-melt adhesive composition to the substrate, various hot-melt applicators can be used and, for example, a method using a spray gun, a comma coater, a die coater, a roll coater, or the like may be employed. When applying the hot-melt adhesive composition to the substrate, the hot-melt adhesive composition is usually melted by heating at a temperature of 140° C. to 200° C., and can be applied in a molten state. The hot-melt adhesive composition may be applied to a release film or a release paper and then thermally transferred to another substrate before use. After the application, the resulting hot-melt adhesive layer may be solidified on the substrate by cooling. A precoated substrate (adhesive layer-containing substrate) obtained after the coating step may be directly used in the subsequent molding step, or may be stored before being used in the subsequent step.

### Bonding Step

In the bonding step, if necessary, the hot-melt adhesive layer may be heat-activated and melted again. Examples of a heat activation means comprise, but not particularly limited to, methods using heat, ultrasonic waves, high-frequency waves, or microwaves. This re-activation is preferably performed just before compressing bonding of the precoated substrate and the second substrate. The precoated substrate and the second substrate are compression-bonded before the surface of the hot-melt adhesive composition layer is solidified. Examples of a compressing bonding method comprise, but not particularly limited to, a compression molding method and a vacuum molding method. The second substrate may or may not be heated. When the hot-melt adhesive composition layer is in a re-activated state, the second substrate does not have to be heated at the time of the compressing bonding; however, if necessary, the second substrate may be heated simultaneously with compression.

The temperature of the heat activation is 100° C. to 200° C., for example, preferably 100° C. to 180° C., more preferably 120° C. to 160° C., in terms of the surface temperature of the hot-melt adhesive layer. The pressure during the compressing bonding that relates to bonding of the first substrate and the second substrate may be 0.01 to 0.50 MPa, and it is preferably 0.01 to 0.20 MPa, more preferably 0.01 to 0.10 MPa. The time of the compressing bonding may be, for example, 1 to 300 seconds, and it is preferably 1 to 60 seconds, more preferably 10 to 30 seconds.

### <Automobile Interior Material and Production Method Thereof>

### Automobile Interior Material

The automobile interior material of the present disclosure comprises: a molded article for automobile interior; and a surface material for automobile interior (hereinafter, also referred to as “surface material”), which is bonded to the molded article for automobile interior via a hot-melt adhesive layer formed from the hot-melt adhesive composition of the present disclosure. The surface material may be derived from a hot-melt adhesive layer-containing surface material (precoated surface material). Examples of the automobile interior material comprise door trims, instrument panels, headliners (or ceiling materials), rear trays, and pillars.

The material of the molded article for automobile interior is not particularly limited as long as it is a material that is used in an automobile interior material, and examples thereof comprise: woody materials, such as paper and wood; polyolefins (e.g., polypropylenes, polyethylenes, and ethylene-propylene copolymers); plastic materials, such as polyvinyl chlorides, polyurethanes, polyesters, epoxy resins, nylon, polyesters, polycarbonates, polyurethanes, acryl, ABS, and PCABS; rubber materials, such as natural rubber and synthetic rubber; metal materials, such as aluminum, iron, and stainless steel; and inorganic materials, such as ceramics. The molded article for automobile interior may consist of one kind of material, or may be composed of two or more kinds of materials. The material of the surface of the molded article for automobile interior on which the adhesive layer is formed is preferably any of the above-described materials of the molded article for automobile interior, which is a non-metal material, more preferably any of the above-described materials of the molded article for automobile interior, which is a resin, still more preferably a polyolefin, such as a polypropylene.

The surface material is not particularly limited as long as it is made of a material that is used in an automobile interior material, and examples thereof comprise: plastic sheets made of a polyolefin, a soft polyvinyl chloride, a polyurethane, or the like; foams of the above-exemplified plastic materials; rubber sheets of natural rubber or synthetic rubber, fabric materials, such as woven fabrics and nonwoven fabrics; and metal foils of aluminum and the like. The surface material may consist of a single layer, or may comprise two or more layers made of the same material or different materials. Examples of the surface material comprising two or more layers comprise sheet materials obtained by laminating one or more layers of any of the above-described plastic foams on one or more layers of any of the above-described plastic sheets, rubber sheets, fabric materials, metal foils, and the like. Examples of such laminated sheet materials comprise polyolefin foam-lined soft polyvinyl chloride sheets, polyolefin foam-lined olefin-based thermoplastic elastomer sheets, and polyurethane foam-lined fabrics. The material of the surface of the surface material on which the adhesive layer is formed is preferably any of the above-described surface materials that is a non-metal material, more preferably any of the above-described surface materials that is a resin, still more preferably a polyolefin, such as a polypropylene.

### Method of Producing Automobile Interior Material

A method of producing the automobile interior material of the present disclosure may be the above-described bonded body production method in which the bonded body is the automobile interior material, the first substrate is a surface material, and the second substrate is a molded article for automobile interior. Conversely, the bonded body may be the automobile interior material, the first substrate may be a molded article for automobile interior, and the second substrate may be a surface material.

The method of producing the automobile interior material may comprise, for example: a step of applying the hot-melt adhesive composition of the present disclosure to the back surface of a surface material (e.g., the surface of a foam layer of the surface material) to obtain a hot-melt adhesive layer-containing surface material (precoated surface material); and a step of re-activating the thus obtained precoated surface material using a far-infrared heater or the like, melting the hot-melt adhesive layer, and then compression-bonding the surface material with a molded article for automobile interior via the hot-melt adhesive layer. The method may further comprise a step of curing the hot-melt adhesive layer to crystallize the same. When heat compression-bonding is possible in the step of compression-bonding the surface material with a substrate, the re-activation using a far-infrared heater or the like may be unnecessary. It is noted here that the “back surface” of the surface material means the surface that faces the molded article for automobile interior at the time of bonding the surface material with the molded article for automobile interior.

### EXAMPLES

The present disclosure will now be described more concretely by way of Examples and Comparative Examples; however, the present disclosure is not limited thereto by any means.

The components used in Examples and Comparative Examples are shown below.

(A) α-Olefin (Co)Polymer that is Produced Using Single-Site Catalyst and has Shore A Hardness of 80 or More
A-1: WINTEC WSX03 manufactured by Japan Polypropylene Corporation (melting point: 125° C., Shore A hardness: 98, polypropylene produced using a single-site catalyst)
A-2: VERSIFY 3000 manufactured by Dow Chemical Company (melting point: 108° C., Shore A hardness: 96, propylene-ethylene copolymer produced using a single-site catalyst)
A-3: TAFMER XM-7090 manufactured by Mitsui Chemicals, Inc. (melting point: 98° C., Shore A hardness: 97, propylene-butene copolymer produced using a single-site catalyst)
A-4: VISTAMAXX 3588FL manufactured by Exxon Mobil Corporation (melting point: 108° C., Shore A hardness: 94, ethylene content: 4% by weight, propylene-ethylene copolymer produced using a single-site catalyst)
A-5: VISTAMAXX 3980FL manufactured by Exxon Mobil Corporation (melting point: 78° C., Shore A hardness: 84, ethylene content: 9% by weight, propylene-ethylene copolymer produced using a single-site catalyst)
A-6: L-MODU S901 manufactured by Idemitsu Kosan Co., Ltd. (melting point: 80° C., Shore A hardness: 84, polypropylene produced using a single-site catalyst)
   (B) α-Olefin (Co)Polymer that is Produced Using Single-Site Catalyst and has Shore A Hardness of Less than 80
B-1: TAFMER PN-2070 manufactured by Mitsui Chemicals, Inc. (melting point: 140° C., Shore A hardness: 75, propylene polymer produced using a single-site catalyst)
B-2: VISTAMAXX 6502 manufactured by Exxon Mobil Corporation (melting point: 63° C., Vicat softening point: 51° C., Shore A hardness: 71, ethylene content: 13% by weight, propylene-ethylene copolymer produced using a single-site catalyst)
B-3: VISTAMAXX 6202 manufactured by Exxon Mobil Corporation (melting point: 60° C., Vicat softening point: 45° C., Shore A hardness: 64, ethylene content: 15% by weight, propylene-ethylene copolymer produced using a single-site catalyst)

### (C) Ethylene-Polar Group-Containing Monomer Copolymer

C-1: ULTRATHENE 722 manufactured by Tosoh Corporation (melting point: 65° C., Shore A hardness: 69, vinyl acetate content: 28% by weight, ethylene-vinyl acetate copolymer)
C-2: NUC-6070 manufactured by ENEOS NUC Corporation (melting point: 87° C., Shore A hardness: 79, ethyl acrylate content: 25% by weight, ethylene-ethyl acrylate copolymer)
   (X) α-Olefin (Co)Polymer that is Produced Using Multi-Site Catalyst
X-1: VESTOPLAST 792 manufactured by Evonik Degussa GmbH (softening point: 108° C., Shore A hardness: 70, weight-average molecular weight: 118,000, amorphous polyolefin produced using a multi-site catalyst)

### (D) Polypropylene-Based Wax

D-1: VISCOL 660-P manufactured by Sanyo Chemical Industries, Ltd. (softening point: 145° C., weight-average molecular weight: 10,000, polypropylene-based wax)
D′-2: SANWAX 171-P manufactured by Sanyo Chemical Industries, Ltd. (softening point: 107° C., weight-average molecular weight: 10,000, polyethylene wax)

### (E) Tackifier

E-1: ARKON P115 manufactured by Arakawa Chemical Industries, Ltd. (softening point: 115° C., hydrogenated petroleum-based tackifier)
E-2: YS RESIN PX1150 manufactured by Yasuhara Chemical Co., Ltd. (softening point: 115° C., terpene-based tackifier)
E-3: YS POLYSTER UH115 manufactured by Yasuhara Chemical Co., Ltd. (softening point: 115° C., hydrogenated terpene phenol-based tackifier) (F) Additive (Antioxidant)
F-1: IRGANOX 1010 manufactured by BASF Ltd. (melting point: 110° C., hindered phenol-based antioxidant)
F-2: IRGAFOS 168 manufactured by BASF Ltd. (melting point: 183° C., phosphorus-based antioxidant)

### Examples 1 to 13 and Comparative Examples 1 to 7

Hot-melt adhesive compositions of Examples 1 to 13 and Comparative Examples 1 to 7 were obtained by melt-mixing the components shown in Tables 1 to 3 below in the respective amounts (parts by mass) at 180° C. using a mixing stirrer equipped with a heat medium jacket (kneader manufactured by PRIMIX Corporation, HIVIS MIX 2P-1).

For the thus obtained hot-melt adhesive compositions of Examples 1 to 13 and Comparative Examples 1 to 7, the melt viscosity was measured. Further, the crack resistance and the blocking resistance were evaluated. Moreover, bonding test samples were prepared, and the initial creep, the bonding strength, and the heat-resistant creep were evaluated. The evaluation methods, the measurement methods, and the like are described below.

### Melt Viscosity

The melt viscosity was measured using a parallel plate-type rheometer (MCR102e, manufactured by Anton Paar GmbH) at a temperature of 180° C., a shear rate of 4.3 sec⁻¹, and a clearance of 0.5 mm. The results thereof are shown in Tables 1 to 3.

### Crack Resistance

The above-obtained adhesives were each applied to the surface of a foam layer of a surface material (artificial leather formed from thermoplastic polyolefin/polypropylene foam layer, total thickness: 4 mm) at 180° C. using a roll coater such that an adhesive layer was formed in an amount of 100 g/m². Subsequently, after a lapse of one day after the application of the adhesive, the surface material was seam-folded in a 23° C. environment such that the adhesive layer was arranged on the outside. Thereafter, the presence or absence of a crack in the adhesive layer was visually observed and evaluated. The results thereof are shown in Tables 1 to 3.
Good (G): No crack was observed.
Poor (P): A crack was observed.

### Blocking Resistance (and Component Migration Resistance)

The above-obtained adhesives were each applied to the surface of a foam layer of a surface material (artificial leather formed from thermoplastic polyolefin/polypropylene foam layer, total thickness: 4 mm) at 180° C. using a roll coater such that an adhesive layer was formed in an amount of 100 g/m². Subsequently, within 30 minutes after the application of the adhesive, the surface material was laminated in five layers and left to stand in a 40° C. oven for 3 days, with a load of 1.28 kPa being applied thereto using a glass flat plate and a weight. Thereafter, the laminated surface materials were taken out of the oven and peeled off from each other by hand, after which the peeled surfaces were visually observed to evaluate the presence or absence of blocking and component migration between the surface materials. The results thereof are shown in Tables 1 to 3.
Good (G): Neither blocking nor component migration was observed.
Poor (P): Either blocking or component migration was observed.

### Preparation of Bonding Test Sample 1

The above-obtained adhesives were each applied to the surface of a foam layer of a surface material (artificial leather formed from thermoplastic polyolefin/polypropylene foam layer, total thickness: 4 mm) at 180° C. using a roll coater such that an adhesive layer was formed in an amount of 100 g/m². Subsequently, within one day after the application of the adhesive, the surface material was heated to 170° C. or higher using a far-infrared heater and then immediately disposed on a PP board (flat plate molded from polypropylene, thickness: 2 mm), after which the resultant was pressed at 0.1 MPa for 15 seconds to obtain a laminate (bonding test sample 1).

### Initial Creep

After obtaining the laminate (bonding test sample 1), a load of 200 g/25 mm was applied thereto at an angle of 90° in a 60° C. atmosphere, and the peeling length (mm) was measured after 5 minutes. The results thereof are shown in Tables 1 to 3.

### Bonding Strength

After curing the laminate (bonding test sample 1) at 25° C. for 24 hours, the peel strength (N/25 mm) in 1800 peeling was measured. The PP board was immobilized with a jig, and the surface material was peeled off in a pulling manner. The measurement was performed at a peeling speed of 200 mm/min. Further, the state of the peeled surface was visually observed. The results thereof are shown in Tables 1 to 3.
AF: Interfacial failure on the substrate side
MB: Material failure of the surface material
CF: Cohesion failure of the adhesive

The numbers after the failure state each indicate a ratio of the failure state.

### Heat-Resistant Creep

After curing the laminate (bonding test sample 1) at 25° C. for 24 hours, a load of 200 g/25 mm was applied thereto at an angle of 90° in an 80° C. atmosphere, and the peeling length (mm) was measured after 24 hours. Further, the state of the peeled surface was visually observed. The results thereof are shown in Tables 1 to 3.
AF: Interfacial failure on the substrate side
MB: Material failure of the surface material
CF: Cohesion failure of the adhesive

The numbers following the failure state each indicate a ratio of the failure state.

TABLE 1

| | | Example | | | | | | |
|---|---|---|---|---|---|---|---|---|
| | | 1 | 2 | 3 | 4 | 5 | 6 | 7 |
| (A) | A-1 | 3 | 5 | | | | | |
| | A-2 | | | 5 | | | | |
| | A-3 | | | | 5 | | | |
| | A-4 | | | | | 10 | | |
| | A-5 | | | | | | 10 | |
| | A-6 | | | | | | | 15 |
| (B) | B-1 | 10 | 10 | 10 | 10 | | | 10 |
| | B-2 | 12 | 10 | 10 | 10 | 15 | 15 | |
| | B-3 | | | | | | | |
| (X) | X-1 | | | | | | | |
| (C) | C-1 | 10 | 10 | 10 | 10 | 10 | 10 | 10 |
| | C-2 | | | | | | | |
| (D) | D-1 | 40 | 40 | 40 | 40 | 40 | 40 | 40 |
| | D′-2 | | | | | | | |
| (E) | E-1 | 25 | 25 | 25 | 25 | 25 | 25 | 25 |
| | E-2 | | | | | | | |
| | E-3 | | | | | | | |
| (F) | F-1 | 0.5 | 0.5 | 0.5 | 0.5 | 0.5 | 0.5 | 0.5 |
| | F-2 | 0.5 | 0.5 | 0.5 | 0.5 | 0.5 | 0.5 | 0.5 |
| Total | | 101 | 101 | 101 | 101 | 101 | 101 | 101 |
| Wax ratio | (parts by mass) | 114 | 114 | 114 | 114 | 114 | 114 | 114 |
| Melt viscosity | (mPa · s) | 27,000 | 21,000 | 24,000 | 25,000 | 25,000 | 22,000 | 21,000 |
| | 180° C. | | | | | | | |
| Crack resistance | | G | G | G | G | G | G | G |
| Blocking resistance | | G | G | G | G | G | G | G |
| Initial creep | (mm) | 0 | 0 | 0 | 1 | 0 | 0 | 0 |
| Bonding strength | (N/25 mm) | 25 | 25 | 25 | 25 | 25 | 25 | 25 |
| | | FB100 | FB100 | FB100 | FB100 | FB100 | FB100 | FB100 |
| Heat-resistant creep | (mm) | 0 | 0 | 0 | 0 | 0 | 0 | 0 |

TABLE 2

| | | Example | | | | | |
|---|---|---|---|---|---|---|---|
| | | 8 | 9 | 10 | 11 | 12 | 13 |
| (A) | A-1 | 5 | 5 | 5 | 5 | 5 | 5 |
| | A-2 | | | | | | |
| | A-3 | | | | | | |
| | A-4 | | | | | | |
| | A-5 | | | | | | |
| | A-6 | | | | | | |
| (B) | B-1 | 10 | 5 | | 10 | 10 | 10 |
| | B-2 | | 15 | 20 | 10 | 10 | 10 |
| | B-3 | 10 | | | | | |
| (X) | X-1 | | | | | | |
| (C) | C-1 | 10 | 10 | 10 | | 10 | 10 |
| | C-2 | | | | 10 | | |
| (D) | D-1 | 40 | 40 | 40 | 40 | 40 | 40 |
| | D′-2 | | | | | | |
| (E) | E-1 | 25 | 25 | 25 | 25 | | |
| | E-2 | | | | | 25 | |
| | E-3 | | | | | | 25 |
| (F) | F-1 | 0.5 | 0.5 | 0.5 | 0.5 | 0.5 | 0.5 |
| | F-2 | 0.5 | 0.5 | 0.5 | 0.5 | 0.5 | 0.5 |
| Total | | 101 | 101 | 101 | 101 | 101 | 101 |
| Wax ratio | (parts by mass) | 114 | 114 | 114 | 114 | 114 | 114 |
| Melt viscosity | (mPa · s) | 28,000 | 18,000 | 15,000 | 20,000 | 30,000 | 28,000 |
| | 180° C. | | | | | | |
| Crack resistance | | G | G | G | G | G | G |
| Blocking resistance | | G | G | G | G | G | G |
| Initial creep | (mm) | 0 | 1 | 2 | 0 | 0 | 0 |
| Bonding strength | (N/25 mm) | 25 | 25 | 25 | 25 | 25 | 25 |
| | | FB100 | FB100 | FB100 | FB100 | FB100 | FB100 |
| Heat-resistant creep | (mm) | 0 | 5 | 10 | 0 | 0 | 0 |
| | | | CF100 | CF100 | | | |

TABLE 3

| | | Comparative Example | | | | | | |
|---|---|---|---|---|---|---|---|---|
| | | 1 | 2 | 3 | 4 | 5 | 6 | 7 |
| (A) | A-1 | 5 | | | 25 | 5 | 5 | 5 |
| | A-2 | | | | | | | |
| | A-3 | | | | | | | |
| | A-4 | | | | | | | |
| | A-5 | | | | | | | |
| | A-6 | | | | | | | |
| (B) | B-1 | | 5 | | | 10 | 10 | 10 |
| | B-2 | | | | | | 10 | 10 |
| | B-3 | | | 25 | | 20 | | |
| (X) | X-1 | 20 | 20 | | | | | |
| (C) | C-1 | 10 | 10 | 10 | 10 | | 10 | 10 |
| | C-2 | | | | | | | |
| (D) | D-1 | 40 | 40 | 40 | 40 | 40 | | 15 |
| | D′-2 | | | | | | 40 | |
| (E) | E-1 | 25 | 25 | 25 | 25 | 25 | 25 | 50 |
| | E-2 | | | | | | | |
| | E-3 | | | | | | | |
| (F) | F-1 | 0.5 | 0.5 | 0.5 | 0.5 | 0.5 | 0.5 | 0.5 |
| | F-2 | 0.5 | 0.5 | 0.5 | 0.5 | 0.5 | 0.5 | 0.5 |
| Total | | 101 | 101 | 101 | 101 | 101 | 101 | 101 |
| Wax ratio | (parts by | 114 | 114 | 114 | 114 | 114 | 114 | 43 |
| | mass) | | | | | | | |
| Melt viscosity | (mPa · s) | 8,000 | 12,000 | 25,000 | 20,000 | 70,000 | 8,000 | 55,000 |
| | 180° C. | | | | | | | |
| Crack | | P | G | G | P | G | G | P |
| resistance | | | | | | | | |
| Blocking | | — | P | P | — | P | P | — |
| resistance | | | | | | | | |
| Initial creep | (mm) | could not be | 2 | 1 | could not be | 0 | 2 | could not be |
| | | evaluated | | | evaluated | | | evaluated |
| Bonding | (N/25 mm) | could not be | 25 | 25 | could not be | 25 | 25 | could not be |
| strength | | evaluated | FB100 | FB100 | evaluated | FB100 | FB100 | evaluated |
| Heat-resistant | (mm) | could not be | >50 | >50 | could not be | 0 | >50 | could not be |
| creep | | evaluated | CF100 | CF100 | evaluated | | CF100 | evaluated |

The hot-melt adhesive compositions of Examples 1 to 13 all exhibited good adhesion, heat resistance, crack resistance, and blocking resistance.

On the other band, the hot-melt adhesive compositions of Comparative Examples 1 to 7 were insufficient in at least one of the adhesion, the heat resistance, the crack resistance, and the blocking resistance.

In the hot-melt adhesive compositions of Comparative Examples 1 and 2, since an amorphous polyolefin (X) produced using a multi-site catalyst was used in place of the component (B), the blocking resistance, the heat-resistant creep, and the like were insufficient.

The hot-melt adhesive composition of Comparative Example 3 did not comprise the component (A) and, therefore, was insufficient in the blocking resistance and the heat-resistant creep.

The hot-melt adhesive composition of Comparative Example 4 did not comprise the component (B) and, therefore, was insufficient in the crack resistance. The hot-melt adhesive composition of Comparative Example 5 did not comprise the component (C) and, therefore, was insufficient in the blocking resistance. In the hot-melt adhesive composition of Comparative Example 6, since a polyethylene wax was used in place of the polypropylene-based wax (D), the heat-resistant creep was reduced.

The hot-melt adhesive composition of Comparative Example 7 did not comprise a sufficient amount of the polypropylene-based wax (D), and thus exhibited poor compatibility and insufficient crack resistance.

### INDUSTRIAL APPLICABILITY

The hot-melt adhesive composition of the present disclosure can be utilized as, for example, a solvent-free adhesive without VOC emissions, and exhibits excellent adhesion to resin substrates, particularly olefin substrates, as well as excellent heat resistance. Further, in the production of a precoated surface material, the hot-melt adhesive composition of the present disclosure exhibits excellent blocking resistance and component migration resistance during storage of the resulting laminate, as well as excellent crack resistance during transport; therefore, it can be preferably used as an adhesive for automobile interior.

1. A hot-melt adhesive composition, comprising:
an α-olefin (co)polymer (A) that is produced using a single-site catalyst and has a Shore A hardness of 80 or more;
an α-olefin (co)polymer (B) that is produced using a single-site catalyst and has a Shore A hardness of less than 80;
an ethylene-polar group-containing monomer copolymer (C); and
a polypropylene-based wax (D),
wherein the polypropylene-based wax (D) is comprised in an amount of 60 parts by mass to 300 parts by mass with respect to a total of 100 parts by mass of the α-olefin (co)polymer (A), the α-olefin (co)polymer (B), and the ethylene-polar group-containing monomer copolymer (C).

2. The hot-melt adhesive composition according to claim 1, wherein the α-olefin (co)polymer (A) comprises at least one selected from the group consisting of polypropylenes, ethylene-propylene copolymers, and propylene-butene copolymers.

3. The hot-melt adhesive composition according to claim 1, wherein the α-olefin (co)polymer (B) comprises a repeating unit derived from propylene as a part of a copolymerized component.

4. The hot-melt adhesive composition according to claim 1, wherein the ethylene-polar group-containing monomer copolymer (C) comprises at least one selected from the group consisting of ethylene-vinyl acetate copolymers and ethylene-ethyl acrylate copolymers.

5. The hot-melt adhesive composition according to claim 1, wherein the polypropylene-based wax (D) has a softening point of 90° C. or higher.

6. The hot-melt adhesive composition according to claim 1, comprising a tackifier (E).

7. The hot-melt adhesive composition according to claim 6, wherein the tackifier (E) comprises at least one selected from the group consisting of hydrogenated petroleum resins, terpene resins, and hydrogenated terpene phenol resins.

8. The hot-melt adhesive composition according to claim 1, comprising an antioxidant (F).

9. The hot-melt adhesive composition according to claim 1, having a melt viscosity of 10,000 mPa·s to 50,000 mPa·s at 180° C.

10. The hot-melt adhesive composition according to claim 1, which is for an automobile interior material.

11. A precoated surface material for automobile interior, comprising:
a surface material for automobile interior; and
a hot-melt adhesive layer formed from the hot-melt adhesive composition according to any one of claim 1 on the back surface of the surface material for automobile interior.

12. An automobile interior material, comprising:
a molded article for automobile interior; and
the precoated surface material for automobile interior according to claim 11, which is bonded to the molded article for automobile interior via the hot-melt adhesive layer.

13. A method of producing a bonded body,
wherein
the bonded body comprises: a first substrate; and a second substrate bonded to the first substrate via a hot-melt adhesive layer formed from the hot-melt adhesive composition according to any one of claim 1, and
the method comprises a step of bringing a mold and the hot-melt adhesive composition into contact.

14. A method of producing a hot-melt adhesive composition, the method comprising:
preparing an α-olefin (co)polymer (A) that is produced using a single-site catalyst and has a Shore A hardness of 80 or more, an α-olefin (co)polymer (B) that is produced using a single-site catalyst and has a Shore A hardness of less than 80, an ethylene-polar group-containing monomer copolymer (C), and a polypropylene-based wax (D); and
melt-mixing the polypropylene-based wax (D) in an amount of 60 parts by mass to 300 parts by mass with respect to a total of 100 parts by mass of the α-olefin (co)polymer (A), the α-olefin (co)polymer (B), and the ethylene-polar group-containing monomer copolymer (C).
